(19) United States
(12) Patent Application Publication
(10) Pub. No.: US 2003/0199287 A1
(43) Pub. Date: Oct. 23, 2003

(54) ICS adapter

(76) Inventor: Christian E. Baechli, San Diego, CA (US)

Correspondence Address: BAECHLI CHRISTIAN, 888 ARMADA TER, SAN DIEGO, CA, 92106, US

(21) Appl. No.: 10/127,146

(22) Filed: Apr. 22, 2002

(51) Int. Cl. H04M 1/00

(52) U.S. Cl. 455/557; 455/431

(57) ABSTRACT

The ICS adapter connects incompatible or separate radio communication networks. It enables control and integration by providing simultaneous 2 way voice communication access to all connected systems.

### STATEMENT REGARDING FEDERALLY SPONSORED RESEARCH OR DEVELOPMENT

Not Applicable

### REFERENCE TO MICROFICHE INDEX

Not Applicable

### BACKGROUND OF THE INVENTION

The invention is intended to serve within an environment of special flight operations for rotary wing aviation communities. However, its application is not limited to aircraft based applications.

The specific task of an airborne operator to coordinate flight mission and ground based operations requires seamless communication capabilities between all involved parties. The airborne operator needs to be able to directly communicate with Pilot/Aircrew and ground forces at his discretion. If the aircraft installed radio system and ground force based radio system are not compatible, the airborne operator is required to utilize a second radio that provides communication capability to operating ground forces.

Since the flight helmet integrated headset is designed to accommodate the aircraft's communication system only, a separate handheld radio or radio station to communuicate with other networks is required. This compropmises the operators freedom of communication due to multiplicity of equipment and systems.

Existing solutions to this problem require the operator to wear a separate headset inside the mounted flight helmet, which lowers the technical integrity and comfort level of the helmet by causing hotspots due to bulk.

The proposed solution does not require any modification to existing quipment or systems. It simply connects the different components by plug and provides complete integrity. The device is designed on individual customer requirements based on platform specific communication systems and radio networks currently in use.

### BRIEF SUMMARY OF THE INVENTION

A device (ICS adapter) that plugs in to a helmet integrated headset and one or multiple handheld radio transmitters and wire-based platform installed communication systems typically used in aircraft, ships, boats and armored vehicles.

The device (ICS adapter) can be modified to accommodate several different type/models of handheld radios/radio stations and platforms. Its detailed design is based on customer specific requirements.

### BRIEF DESCRIPTION OF THE SEVERAL VIEWS OF THE DRAWING

Not Applicable

### DETAILED DESCRIPTION OF THE INVENTION

The invention is a device (ICS adapter) that virtually connects two or multiple radio communication networks. It enables the user to fully access and monitor all connected networks. The device plugs into a headset and one or multiple handheld radio transmitters, and fixed-wire platform installed communication systems, typically used in aircraft, ship, boat and armored vehicles.

The device (ICS adapter) contains a push to talk (PTT) button for each system connected. The cable/connector configuration varies and depends upon given system, brand and model of radio connected.

Functionality:

A signal converter modifies microphone and speaker signals to accommodate the specific systems connected. Helmet mounted amplifiers are powered by a device installed battery if necessary. A relay module manages receive and transmitter modes, based on the PTT switch signal given. Cable mounted connectors establish physical connection to headset, platform based system, and one or more mobile radio stations/handheld radios.

Parts:

All required parts are available through commercial sources.

I claim as my invention:

1. The idea of applying a device (ICS adapter) that enables the virtual connection of one or multiple radio voice communication networks. This device is connected to two or more handheld or permanent installed radio transmitters, a wire based integrated communication system (ICS), and personnel mounted headset.
Combination and wiring of electronic components that build the circuit and provide its functionality as described.
